(19) United States
(12) Patent Application Publication
(10) Pub. No.: US 2007/0194910 A1
(43) Pub. Date: Aug. 23, 2007

(54) REAL TIME PERSONNEL LOCATION SYSTEM AND METHOD

(75) Inventor: Michel MONNERAT, L'Union (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/616,935

(22) Filed: Dec. 28, 2006

(30) Foreign Application Priority Data
Dec. 29, 2005 (FR) 0554129

(51) Int. Cl. G08B 1/08

(52) U.S. Cl. 340/539.13

(57) ABSTRACT

The invention relates to a system for locating personnel inside a place of intervention, said system comprising at least three intervention vehicles and at least three subsystems comprising a BTS type radio base station and an RNSS receiver connected to said station, a subsystem being attached to a respective vehicle to synchronize and locate each of the base stations by means of the receiver, each of said stations being adapted to transmit a synchronized position signal, said system further comprising a communication device that can be carried by the personnel, said device and each of said stations being adapted to communicate with each other to transmit a respective range signal indicative of the distance between the communication device and each of the base stations, said system comprising a location server that is adapted to receive the position and range signals, said server being adapted to locate said device in real time by triangulation using said received signals.

### CROSS-REFERENCE TO RELATED APPLICATIONS

This application is based on French Patent Application No. 0554129 filed Dec. 29, 2005, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a system for locating personnel inside a place of intervention, a location method and an intervention vehicle for such a system.

The invention typically applies to the location of at least one firefighter in his place of intervention, notably inside a building.

2. Description of the Prior Art

For reasons of safety, but also of efficacious intervention, it is desirable to be able to locate in real time a firefighter inside the building in which he is intervening. In particular, the location may be used by the firefighter himself as he moves around, but also by the intervention control station so as to direct the firefighters involved in the operation relative to each other.

However, within a building, GPS (Global Positioning System) type location is not available because of the confined environment, which prevents communication with satellites.

To enable them to position themselves, firefighters have available to them portable acoustic systems that enable them to position themselves relative to each other. However, given the operating conditions, in particular background noise, the reliability of this solution is not assured.

Moreover, this solution cannot locate personnel in a known frame of reference, but only relative to surrounding personnel, and can therefore neither supply the location to the control station nor locate the firefighter relative to the architecture of the place of intervention.

Moreover, the use of any networks available in the place of intervention, apart from their hypothetical character, is not reliable because of the high probability of them being damaged by the incident to be fought.

Consequently, there also exists a problem of making reliable the possibility of communication between the intervening personnel or between personnel and the exterior of the place of intervention.

An object of the invention is to alleviate these drawbacks by proposing in particular an autonomous system and a method adapted to locate a firefighter accurately in his place of intervention with a reliability that is independent of the conditions of intervention. Moreover, the invention makes reliable the possibility of communicating with personnel in or from the place of intervention.

### SUMMARY OF THE INVENTION

To this end, and in accordance with a first aspect, the invention proposes a system for locating personnel inside a place of intervention, said system comprising at least three intervention vehicles and at least three subsystems comprising a BTS type radio base station and an RNSS receiver connected to said station, a subsystem being attached to a respective vehicle to synchronize and locate each of the base stations by means of the receiver, each of said stations being adapted to transmit a synchronized position signal, said system further comprising a communication device that can be carried by the personnel, said device and each of said stations being adapted to communicate with each other to transmit a respective range signal indicative of the distance between the communication device and each of the base stations, said system comprising a location server that is adapted to receive the position and range signals, said server being adapted to locate said device in real time by triangulation using said received signals.

According to a second aspect, the invention proposes a method of locating personnel inside a place of intervention, said method providing for equipping at least three intervention vehicles with a subsystem comprising a BTS type radio base station and an RNSS receiver connected to said station, said vehicles being positioned in the vicinity of the place of intervention, in which method, in real time:

each base station is located and synchronized by means of the receiver that is connected to it;

a synchronized position signal of each of the radio base stations is transmitted to a location server;

respective range signals indicative of the distance between a communication device carried by a person and each of the base stations are measured and transmitted to the location server;

the server calculates the location of the personnel by triangulation using the synchronized position signals and the range signals.

According to a third aspect, the invention proposes an intervention vehicle for a location system as specified hereinabove, said vehicle being equipped with a subsystem comprising a BTS type radio station and an RNSS receiver connected to said station to locate it and synchronize it in real time.

### DETAILED DESCRIPTION OF PREFERRED EMBODIMENTS

Other features and advantages of the invention will become apparent in the course of the following description of various particular embodiments.

There is described hereinafter a system for locating personnel inside a place of intervention. In particular, this refers to a firefighter who is operating inside a building to contain a fire. The system is also adapted to locate several persons simultaneously or relative to each other.

In this particular embodiment, but equally in other applications that may be envisaged, it is important that the firefighter be able to locate himself relative to a known frame of reference, in particular relative to the architecture of the building. For reasons of safety and efficacy, it is equally useful to be able to locate, relative to each other, several persons present in the building, as much at the level of a given person as at the level of an operation control station.

The location system described hereinafter provides a reliable response to all of these requirements at the same time as ensuring communication between personnel and their environment, as much outside the place of intervention as inside it.

The system according to the invention comprises at least three subsystems comprising a base transceiver station (BTS) type radio base station and an RNSS (Radio Navigation Satellite System) receiver connected to said station. In one embodiment, the receiver is of the GPS (Global Positioning System), GLONASS or GALILEO type enabling, through satellite communication, determination of the position of the radio base station in a given frame of reference by synchronization and location.

Each of the subsystems is attached to a respective intervention vehicle, so that the location of the vehicles and therefore those of the radio base stations are known in real time. Furthermore, each of the stations is adapted to transmit a signal representative of its synchronized position.

Consequently, the intervention vehicles for the location system are equipped with a subsystem comprising a BTS type radio base station and an RNSS receiver connected to said station to locate it and synchronize it in real time.

The location system also comprises a communication device that can be carried by personnel, such as a GSM (Global System for Mobile communications) mobile telephone. In a manner that is known in the art, the telephone and each of the stations are adapted to communicate with each other to transmit a respective range signal indicative of the distance between said telephone and each of the base stations.

The location system is thus adapted to create a wireless (WiFi) network circumstantially and autonomously, said network being mobile in that it is carried by the intervention vehicles and located within a known frame of reference by means of the receivers.

If at least one of the intervention vehicles carries a ladder, the reliability of the wireless network may be improved by attaching the radio base station in the vicinity of the upper portion of said ladder, so as to benefit from an antenna effect when said ladder is deployed.

To enable the geographical location of personnel in the wireless network, the system comprises a location server that is adapted to receive the position and range signals. The server is advantageously provided in the intervention control station.

The location server is adapted to locate said device in real time by triangulation by means of the signals received. In one embodiment, the WiFi network comprises four radio base station/receiver subsystems carried by four vehicles for triangulating the mobile telephone in said network using four position and range signals.

Moreover, the WiFi network makes communication by means of the mobile telephones reliable, in the vicinity of the place of intervention, regardless of the status or availability of permanently installed networks.

In one embodiment, the server comprises means adapted to transmit a personnel location signal, the communication device being adapted to receive said signal and comprising means for displaying said location. Accordingly, personnel engaged in the intervention have the benefit of knowing their position in the building in real time.

Moreover, to represent the location of the personnel better, the server may comprise mapping means for the place of intervention, so as to transmit a location signal relative to a map.

In one embodiment, the server comprises personnel location display means and means for communication with the communication device to assist the movement of personnel.

There is described hereinafter a method of locating personnel inside a place of intervention, said method entailing equipping at least three intervention vehicles with a subsystem comprising a BTS type radio base station and an RNSS receiver connected to said station.

The intervention vehicles are positioned in the vicinity of the place of intervention to create the circumstantial mobile WiFi network as described above.

In the location method, in real time:

each base station is located and synchronized by means of the receiver that is connected to it;

a synchronized position signal for each of the radio base stations is transmitted to a location server;

respective range signals indicative of the measured distance between a communication device carried by a person and each of the base stations are transmitted to the location server;

the server calculates the location of the personnel by triangulation using the synchronized position signals and the range signals.

In particular, the location method of the invention imposes no constraints on the positioning of a vehicle relative to another or relative to the place of intervention, except for the broad constraints for obtaining a wireless network around the place of intervention.

Furthermore, given its real time execution, the location method provides for the possibility of moving at least one vehicle during the intervention, without degrading the reliability of location, since the latter is obtained dynamically.

Finally, the method may provide for communicating the location to the communication device and/or assisting the movement of personnel, where appropriate in relation to the location of other personnel, as a function of the calculated location.

There is claimed:

1. A system for locating personnel inside a place of intervention, said system comprising at least three intervention vehicles and at least three subsystems comprising a BTS type radio base station and an RNSS receiver connected to said station, a subsystem being attached to a respective vehicle to synchronize and locate each of the base stations by means of the receiver, each of said stations being adapted to transmit a synchronized position signal, said system further comprising a communication device that can be carried by the personnel, said device and each of said stations being adapted to communicate with each other to transmit a respective range signal indicative of the distance between the communication device and each of the base stations, said system comprising a location server that is adapted to receive the position and range signals, said server being adapted to locate said device in real time by triangulation using said received signals.

2. A location system according to claim 1, comprising four vehicles and four radio base station/receivers subsystems.

3. A location system according to claim 1, wherein said server comprises means adapted to transmit a personnel location signal, the communication device being adapted to receive said signal and comprising means for displaying said location.

4. A location system according to claim 3, wherein said server comprises mapping means for the place of intervention in order to transmit a location signal relative to a map.

5. A location system according to claim 1, wherein said server comprises personnel location display means and means for communication with the communication device to assist movement of personnel.

6. A method of locating personnel inside a place of intervention, said method providing for equipping at least three intervention vehicles with a subsystem comprising a BTS type radio base station and an RNSS receiver connected to said station, said vehicles being positioned in the vicinity of the place of intervention, in which method, in real time:
each base station is located and synchronized by means of the receiver that is connected to it;
a synchronized position signal of each of the radio base stations is transmitted to a location server;
respective range signals between a communication device carried by a person and each of the base stations are measured and transmitted to the location server;
the server calculates the location of the personnel by triangulation using the synchronized position signals and the range signals.

7. A location method according to claim 6, which provides for communicating the location to the communication device.

8. A location method according to claim 6, which provides for assisting movement of personnel, where appropriate in relation to the location of other personnel, as a function of the calculated location.

9. An intervention vehicle for a location system according to claim 1, said vehicle being equipped with a subsystem comprising a BTS type radio station and an RNSS receiver connected to said station to locate it and synchronize it in real time.

10. An intervention vehicle according to claim 9, comprising a ladder, the radio base station being attached in the vicinity of the upper portion of said ladder.
